(19) United States
(12) Patent Application Publication
(10) Pub. No.: US 2026/0184110 A1
(43) Pub. Date: Jul. 2, 2026

(54) PNEUMATIC TIRE

(71) Applicant: Toyo Tire Corporation, Itami-shi (JP)

(72) Inventor: Takuya Sukeyoshi, Itami-shi (JP)

(73) Assignee: Toyo Tire Corporation, Itami-shi (JP)

(21) Appl. No.: 19/428,661

(22) Filed: Dec. 22, 2025

(30) Foreign Application Priority Data
Dec. 26, 2024 (JP) 2024-230453
Dec. 26, 2024 (JP) 2024-230480
Dec. 26, 2024 (JP) 2024-230527

(51) Int. Cl. B60C 9/02; B60C 1/00; B60C 9/20; B60C 11/03

(52) U.S. Cl. CPC B60C 9/02; B60C 1/0025; B60C 1/0041; B60C 9/20; B60C 11/03; B60C 2009/0276; B60C 2009/2016; B60C 2011/0339

(57) ABSTRACT

A pneumatic tire according to an embodiment includes a different color rubber portion provided on a side wall and made of rubber having a lower carbon black content than rubber constituting the side wall, a length in a tire radial direction from a tire radially outer end of the different color rubber portion to an annular protrusion formed at a boundary between a sector and a side plate of a tire vulcanization mold is 8% or more and 28% or less of a tire cross-sectional height, and a first turned-up end of a turned-up portion overlaps a first belt ply in a normal direction of the turned-up portion.

### BACKGROUND OF THE INVENTION

### 1. Field of the Invention

The present invention relates to a pneumatic tire.

### 2. Description of Related Art

A side wall is well-known in which letters, symbols, and pattern portions, such as lines or figures continuously or discontinuously provided in a tire circumferential direction, are made of a different color rubber composition, such as white rubber, and are provided on the side wall to improve the visibility and design of a tire. This type of the side wall is formed, for example, in such a manner that a predetermined portion of unvulcanized black rubber forming the side wall is divided in a radial direction, different color rubber is disposed during the division, and then a black cover rubber layer is provided on the different color rubber to form a green tire, the formed green tire is then vulcanized in a predetermined mold, and then a part of the cover rubber layer is ground away to expose the different color rubber as a pattern portion.

As a technique related to a side wall provided with different color rubber, for example, JP6798876B discloses that a volume of different color rubber is set to 60% or more and 70% or less of a volume of black rubber to prevent a black residue phenomenon in which the black rubber is partially exposed in a pattern portion.

### SUMMARY OF THE INVENTION

In the tire including the side wall provided with the different color rubber as described in JP6798876B, an interface between the different color rubber and the black rubber is present, and thus the number of interfaces is increased as compared to a tire including only a black side wall, and the durability tends to be reduced. In particular, as a tire cross-sectional height decreases, strain tends to concentrate in the vicinity of a tire radially outer end of the different color rubber, making separation more likely to occur.

In consideration of the above points, an object of an embodiment of the invention is to provide a pneumatic tire that can exhibit excellent durability while providing different color rubber on a side wall.

The invention includes an embodiment to be described below.

A pneumatic tire including: a pair of bead portions including a pair of bead cores spaced apart in a tire axial direction and bead fillers each provided on a tire radially outer side of one of the bead cores; a pair of side walls provided on the tire radially outer side from the pair of bead portions; a tread provided between the pair of side walls and having a belt including a plurality of cords covered with rubber and a tread rubber provided on the tire radially outer side of the belt; a carcass ply having a main portion provided between the pair of bead portions, and a turned-up portion extending from the main portion and turned up around the bead cores from a tire axially inner side toward a tire axially outer side; and a different color rubber portion provided on the tire axially outer side of the carcass ply in the side walls and made of rubber having a lower carbon black content than rubber constituting the side walls, in which the pneumatic tire is formed by a tire vulcanization mold having a sector that forms at least a part of the tread and a side plate that comes into contact with the sector and forms at least a part of the side walls, a length in a tire radial direction from a tire radially outer end of the different color rubber portion to an annular protrusion, which is formed at a boundary between the sector and the side plate and continuous in a tire circumferential direction, is 8% or more to 28% or less of a tire cross-sectional height, and a tire radially outer end of the turned-up portion overlaps the belt in a normal direction of the turned-up portion.

According to the embodiment of the invention, separation can be prevented from occurring and durability can be improved in the pneumatic tire with the different color rubber disposed on the side walls.

### BRIEF DESCRIPTION OF THE DRAWINGS

FIG. 1 is a cross-sectional view of a pneumatic tire according to a first embodiment of the invention; and

FIG. 2 is a developed view showing a tread pattern of the pneumatic tire in FIG. 1.

FIG. 3 is a developed view showing a tread pattern of a pneumatic tire according to Modification 1 of the invention;

FIG. 4 is a half cross-sectional view of a pneumatic tire according to Modification 2 of the invention;

FIG. 5 is a half cross-sectional view of a pneumatic tire according to Modification 3 of the invention; and

FIG. 6 is a half cross-sectional view of a pneumatic tire according to Modification 4 of the invention.

### DESCRIPTION OF EMBODIMENTS

Hereinafter, an embodiment will be described with reference to the drawings.

Note that in the drawings, a reference numeral CL indicates a tire equatorial plane and corresponds to a tire axial center. Here, a tire radial direction is a direction perpendicular to a tire rotation axis, and is indicated by a reference numeral RD in the drawing. A tire radially inner side is a direction toward the tire rotation axis, and a tire radially outer side is a direction away from the tire rotation axis. A tire axial direction is a direction parallel to the tire rotation axis, and is indicated by a reference numeral WD in the drawings. A tire axially inner side is a direction toward the tire axial center CL, and a tire axially outer side is a direction away from the tire axial center CL. A tire circumferential direction is a direction in a circle centered on the tire rotation axis, and is indicated by an arrow CD in the drawing.

In the drawings, a reference numeral E indicates a ground contact end of a tire. The ground contact ends E are at outermost positions of a ground contact surface in the tire axial direction WD. The ground contact surface refers to a surface of a tread portion which comes into contact with a road when the tire is placed perpendicular to a flat road while the tire is assembled to a standard rim and inflated to a standard internal pressure, and is subjected to a standard load.

The standard rim is a rim defined, by a specification on which tires are based, for each tire in a standard system including the specification, and for example, refers to a standard rim in a case of JATMA, and a “measuring rim” in a case of TRA and ETRTO.

A standard load is a load defined, by a specification on which tires are based, for each tire in a specification system including the standard, and refers to a maximum load capacity in the case of JATMA, a maximum value listed in the table above in the case of TRA, and a “load capacity” in the case of ETRTO.

A standard internal pressure refers to a “maximum air pressure” in the JATMA specification, a “maximum value” listed in a “TIRE LOAD LIMITS AT VARIOUS COLD INFLATION PRESSURES” in the TRA specification, or an “INFLATION PRESSURE” in the ETRTO specification.

In the present specification, “overlapping” includes not only a case where tire components such as bead fillers, carcass plies, belt plies, and a tread rubber are in direct contact with each other and overlap each other, but also a case where the tire components overlap each other via another component interposed therebetween.

### (1) Basic Structure of Pneumatic Tire 1

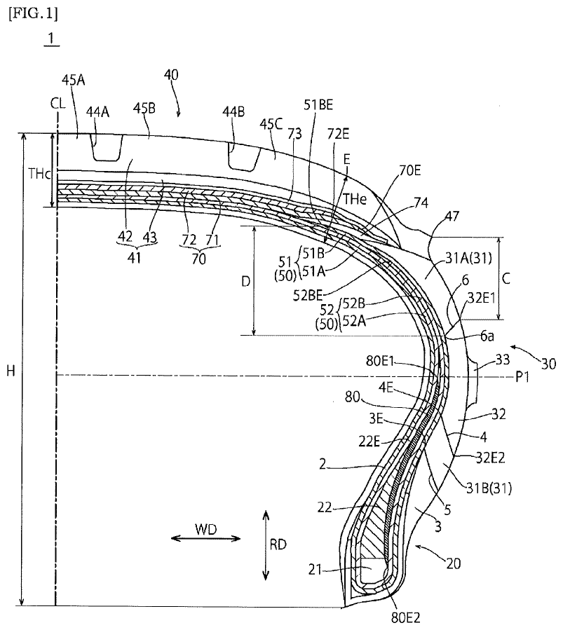

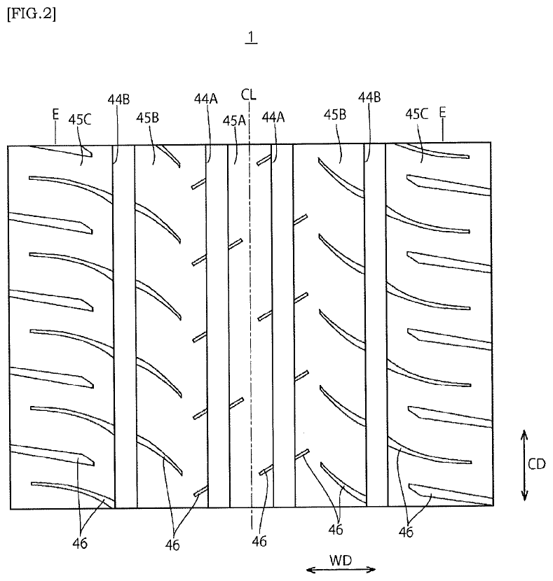

A pneumatic tire 1 according to an embodiment shown in FIGS. 1 and 2 includes a pair of left and right bead portions 20, a pair of left and right side walls 30 extending outward in the tire radial direction from the bead portions 20, and a tread 40 connecting tire radially outer ends of the side walls 30 and constituting a ground contact surface. The pneumatic tire 1 of the present embodiment is a low-profile pneumatic tire having a tire cross-sectional height H of 85 mm or more and 150 mm or less. The tire cross-sectional height H refers to a length in the tire radial direction from an inner diameter surface to an outer diameter surface of the unloaded pneumatic tire 1 mounted on a standard rim and inflated to a standard internal pressure.

A ring-shaped bead core 21 is embedded in each of the pair of bead portions 20. A bead filler 22 tapering toward the tire radially outer side and made of hard rubber is provided on a tire radially outer side of the bead core 21. A rim strip rubber 3 is provided on an outer side in the tire axial direction WD of the bead filler 22 of each of the bead portions 20. The rim strip rubber 3 is a rubber member that forms an outer surface of the bead portion 20 and comes into contact with a wheel rim (not shown) on which the pneumatic tire 1 is mounted.

The pneumatic tire 1 includes a carcass 50 that spans toroidally between the pair of bead portions 20. The carcass 50 extends from the tread 40 through the side walls 30 and is locked by being turned up from the tire axially inner side to the tire axially outer side around the bead cores 21 in the bead portions 20. An inner liner 2 is provided on an inner surface of the carcass 50 as an air permeation-resistant rubber layer.

A side reinforcing layer 80 is provided on the outer side in the tire axial direction WD of the bead filler 22 of each of the bead portions 20. The rim strip rubber 3 is provided on a tire outer side (that is, outer side in the tire axial direction WD) of the carcass 50 in each of the bead portions 20. A side wall rubber 31 and a different color rubber portion 32 are provided on the tire outer side of the carcass 50 in the side walls 30. A belt 70 is provided on an outer side in the tire radial direction RD of the carcass 50 in the tread 40. A belt reinforcing layer 73 and a tread rubber 41 are laminated on an outer side in the tire radial direction RD of the belt 70.

As shown in FIG. 1, an annular protrusion 47 extending in the tire circumferential direction CD is provided in the vicinity of a boundary between the side wall 30 and the tread 40. The annular protrusion 47 is provided continuously around the entire circumference in the tire circumferential direction CD. The annular protrusion 47 is provided at a boundary position (parting line) PL between a sector, which is a mold for molding the tread 40, and a side plate, which is a mold for molding the side wall 30.

### (2) Belt 70

The belt 70 includes at least two belt plies. Each of the belt plies includes a belt cord arranged at an inclination angle of 10 degrees or more and 35 degrees or less, preferably 22 degrees or more and 28 degrees or less with respect to the tire circumferential direction CD. The at least two belt plies are overlapped such that the belt cords cross each other. In this example, the belt has a two-layer structure including a first belt ply 71 disposed on an inner side in the tire radial direction RD and a second belt ply 72 disposed on an outer circumferential side of the first belt ply 71. The first belt ply 71 is a widest belt having a largest width, and an outer end in the tire axial direction WD of the first belt ply 71 corresponds to a tire axially outer end 70E of the belt 70. A steel cord or an organic fiber cord having high tension is used as the belt cord.

In this example, the belt reinforcing layer 73 is provided on the outer side in the tire radial direction RD of the belt 70, that is, between the belt 70 and the tread rubber 41. The belt reinforcing layer 73 is implemented by a cap ply having cords extending substantially parallel to the tire circumferential direction CD.

Furthermore, an underbelt rubber layer 74, which does not include a cord reinforcing material such as an organic fiber or steel cord, is provided between an end in the tire axial direction WD of the first belt ply 71 and the carcass 50.

### (3) Carcass 50

The carcass 50 includes two carcass plies, that is, a first carcass ply 51 and a second carcass ply 52, in which constituent cords extending obliquely with respect to the tire circumferential direction CD are included and are laminated in directions opposite to each other. The carcass plies 51 and 52 are formed into sheets obtained by coating a plurality of parallel-aligned cords with rubber. Examples of the plurality of cords in the carcass plies 51 and 52 include organic fiber cords such as polyester fiber, rayon fiber, aramid fiber, or nylon fiber, or steel cords.

The first carcass ply 51 includes a first main portion 51A that extends from the tread 40 through the side wall 30 to the bead core 21 of the bead portion 20, and a first turned-up portion 51B that extends from the first main portion 51A and is turned up around the bead core 21 from the inner side to the outer side in the tire axial direction WD.

The first main portion 51A passes the inner side in the tire axial direction WD of the bead filler 22 and reaches an inner side in the tire radial direction RD of the bead core 21. The first turned-up portion 51B is wound up to the outer side in the tire radial direction RD from the inner side in the tire radial direction RD of the bead core 21 by passing the outer side in the tire axial direction WD of the bead filler 22.

The second carcass ply 52 includes a second main portion 52A that extends from the tread 40 through the side wall 30 to the bead core 21 of the bead portion 20, and a second turned-up portion 52B that extends from the second main portion 52A and is turned up around the bead core 21 from the inner side to the outer side in the tire axial direction WD.

The second main portion 52A is disposed on the tire radially outer side of the first main portion 51A in the tread 40. The second main portion 52A extends along an outer surface of the first main portion 51A toward the bead portion 20, passes between the first main portion 51A and the bead filler 22, and reaches the inner side in the tire radial direction RD of the bead core 21. The second turned-up portion 52B is wound up to the outer side in the tire radial direction RD from the inner side in the tire radial direction RD of the bead core 21 by passing between the bead filler 22 and the first turned-up portion 51B.

The first turned-up portion 51B of the first carcass ply 51 extends toward and terminates at the inner side in the tire axial direction WD of the outer end 70E of the belt 70. That is, a first turned-up end 51BE, which is an outer end in the tire radial direction RD of the first turned-up portion 51B, is positioned at the inner side in the tire axial direction WD of the outer end 70E of the belt 70, and overlaps the belt 70 in a normal direction of the first turned-up portion 51B. Note that in this example, the first turned-up end 51BE is positioned at the inner side in the tire axial direction WD of a tire axially outer end 72E of the second belt ply 72, and overlaps an end in the tire axial direction WD of the second belt ply 72 in the normal direction of the first turned-up portion 51B.

In this example, the underbelt rubber layer 74 is provided between the first belt ply 71 of the belt 70 and an outer end in the tire radial direction RD of the first turned-up portion 51B, and the first turned-up end 51BE of the first turned-up portion 51B is not in direct contact with the first belt ply 71 of the belt 70, but overlaps the first belt ply 71 via the underbelt rubber layer 74.

The second turned-up portion 52B of the second carcass ply 52 extends toward an outer side in the tire radial direction RD of a tip end (that, tire radially outer end) 22E of the bead filler 22 and terminates before the outer end 70E of the belt 70. More specifically, a second turned-up end 52BE, which is an outer end in the tire radial direction RD of the second turned-up portion 52B, does not overlap the belt 70 in a normal direction of the second turned-up portion 52B, but overlaps the tread rubber 41. The second turned-up end 52BE of the second turned-up portion 52B is sandwiched between the second main portion 52A of the second carcass ply 52 and the first turned-up portion 51B of the first carcass ply 51.

### (4) Tread 40

The tread 40 is provided with the tread rubber 41 on an outer circumferential side (tire radially outer side) of the belt reinforcing layer 73. The tread rubber 41 has a two-layer structure including a cap rubber layer 42 having a tread surface in contact with the road, and a base rubber layer 43 disposed on an inner side in the tire radial direction RD of the cap rubber layer 42. The tread rubber 41 covers an outer end in the tire radial direction RD of the side wall rubber 31 provided on the side wall 30. Note that the tread rubber 41 and the side wall rubber 31 may be disposed such that the outer end in the tire radial direction RD of the side wall rubber 31 covers the end in the tire axial direction WD of the tread rubber 41 from the outside.

A plurality of main grooves 44A and 44B extending along the tire circumferential direction CD are spaced apart in the tire axial direction WD and are formed in the cap rubber layer 42. In this example, a pair of center main grooves 44A are provided on both sides of the tire axial center CL, and a pair of shoulder main grooves 44B are disposed on outer sides of the pair of center main grooves 44A.

A plurality of land portions 45A, 45B, and 45C are defined in the tire axial direction WD by the plurality of main grooves 44A and 44B and are formed in the cap rubber layer 42. That is, the cap rubber layer 42 is provided with the center land portion 45A sandwiched between the pair of center main grooves 44A and 44A, a pair of left and right middle land portions 45B each sandwiched between the center main groove 44A and the shoulder main groove 44B, and a pair of left and right shoulder land portions 45C each formed between the shoulder main groove 44B and the ground contact end E. Lateral grooves 46 extending in a direction intersecting with the tire circumferential direction CD are provided in each of the land portions 45A, 45B, and 45C.

The base rubber layer 43 is implemented by a rubber layer provided on the tire radially outer side of the belt reinforcing layer 73 and having a substantially uniform rubber thickness. The base rubber layer 43 may use a rubber composition having the same rubber hardness as that of a rubber composition constituting the cap rubber layer 42. The base rubber layer 43 may use a rubber composition having lower rubber hardness than that of the rubber composition constituting the cap rubber layer 42.

The cap rubber layer 42 and the base rubber layer 43 constituting the tread rubber 41 preferably use a rubber composition having rubber hardness in a range of 52 to 68.

In the present specification, the rubber hardness is measured at 23° C. using a Type A durometer in accordance with JIS K6253.

In the pneumatic tire 1 of the present embodiment, in a cross section in the tire axial direction WD while the tire is assembled to a standard rim and not inflated with an internal pressure (standard rim assembling and internal pressure uninflated state), a tire thickness THc at the center in the tire axial direction WD is smaller than a tire thickness THe at the ground contact end E.

Here, the tire thickness THc at the tire axial center CL is a tire thickness taken along a normal line to a tire surface profile at the tire axial center CL, and the tire thickness THe at the ground contact end E is a tire thickness taken along a normal line to the tire surface profile at the ground contact end E. The tire surface profile is a contour line of an outer surface of the tread 40 excluding the main grooves 44A and 44B, and is typically defined by a curve formed by smoothly connecting a plurality of arcs.

That is, as shown in FIGS. 1 and 2, when grooves such as the main grooves 44A or lateral grooves 46 are not provided on the tire axial center CL, the tire thickness THc at the tire axial center CL is a length in a normal direction of the outer surface of the tread 40 from an outer surface of the cap rubber layer 42 that forms a tire outer surface to an inner surface of the inner liner 2 that forms a tire inner surface. When a groove is provided on the tire axial center CL, the tire thickness THc is a length in the normal direction of the outer surface of the tread 40 from an opening surface of the groove to the inner surface of the inner liner 2.

When grooves such as the lateral grooves 46 are not provided at the ground contact end E, the tire thickness THe at the ground contact end E is a length in the normal direction of the outer surface of the tread 40 from the outer surface of the cap rubber layer 42 to the inner surface of the inner liner 2. When a groove is provided at the ground contact end E, the tire thickness THe is a length in the normal direction of the outer surface of the tread 40 from the opening surface of the groove to the inner surface of the inner liner 2.

### (5) Side Wall 30

The side wall rubber 31 and the different color rubber portion 32 are provided on the side walls 30. The outer end in the tire radial direction RD of the side wall rubber 31 is joined to the end in the tire axial direction WD of the tread rubber 41, and the inner end in the tire radial direction RD thereof is joined to the outer end in the tire radial direction RD of the rim strip rubber 3. Similar to the tread rubber 41 and the rim strip rubber 3, the side wall rubber 31 uses a black rubber composition (black rubber) containing carbon black as a reinforcing filler.

In the present embodiment, the different color rubber portion 32 is made of white rubber, but the different color rubber portion 32 may be any color rubber as long as rubber contains carbon black less than that of the side wall rubber 31. The white rubber composition constituting the different color rubber portion 32 can use any well-known white rubber composition commonly used for this application, and is not particularly limited.

For example, the different color rubber portion 32 does not contain carbon black as a reinforcing filler, but is made of a rubber composition containing fillers other than carbon black (that is, non-carbon black fillers), such as silica, talc, or clay.

The side wall rubber 31 is made of a rubber composition that is softer (that is, lower in hardness) and has lower rigidity than that of the rim strip rubber 3. The different color rubber portion 32 can use a rubber composition that is lower in hardness and rigidity than those of the black rubber composition containing carbon black that constitutes the rim strip rubber 3 and the side wall rubber 31. As an example, rubber hardness of the rim strip rubber 3 may be 60 to 85, rubber hardness of the side wall rubber 31 may be 50 to 70, and rubber hardness of the different color rubber portion 32 may be 40 to 70.

The different color rubber portion 32 is disposed in a ring shape along the circumferential direction on a part of the side wall 30 in a radial direction. Apart of an outer surface of the different color rubber portion 32 is covered by a cover rubber layer (not shown) made of black rubber of the same color as the side wall rubber 31, and an exposed portion of the different color rubber portion 32 that is not covered serves as a different color display portion 33.

The different color display portion displays a predetermined design, letter, symbol, pattern, or line or figure arranged continuously or discontinuously in the tire circumferential direction on the tire outer surface in a color different from the side wall rubber. This different color display portion 33 may protrude from the tire outer surface. The different color display portion 33 may be provided in a ring shape that is continuous in the tire circumferential direction CD, or may be provided discontinuously along the circumferential direction depending on the shape of the display.

As shown in FIG. 1, the different color rubber portion 32 is provided at a position where a length C in the tire radial direction RD from a tire radially outer end 32E1 of the different color rubber portion 32 to the annular protrusion 47 provided in the vicinity of the boundary between the side wall 30 and the tread 40 is 8% or more and 28% or less of the tire cross-sectional height H.

The ratio of the length C from the tire radially outer end 32E1 of the different color rubber portion 32 to the annular protrusion 47 to the tire cross-sectional height H is set to 8% or more, so that an interface between the different color rubber portion 32 and the side wall rubber 31 on the outer side in the tire radial direction RD can be disposed at a position away from the boundary between the tread 40 and the side wall 30, where strain is likely to occur, thereby preventing the separation from occurring. Preferably, the length C is 17% or more and 26% or less of the tire cross-sectional height H.

Furthermore, by setting this ratio to 28% or less, the different color rubber portion 32 can be disposed at a conspicuous position on the side wall 30, the different color rubber can be exposed without exposing the black side wall rubber in display portions of designs and letters, thereby preventing a deterioration in an appearance quality. An interface 4 on the inner side in the tire radial direction RD between the different color rubber portion 32 and the side wall rubber 31 can be disposed at a position away from the rim strip rubber 3 in contact with the wheel rim when mounted on a vehicle, and the separation can be prevented from occurring. By setting this ratio to 26% or less, the different color rubber can be exposed without exposing the side wall rubber over a wide range in the tire radial direction, and the separation can be further prevented from occurring.

In the present embodiment, the different color rubber portion 32 is provided such that a length D in the tire radial direction from a tire axially inner end 6a of an interface 6 between the different color rubber portion 32 and an upper side wall rubber 31A to the first turned-up end 51BE of the first turned-up portion 51B of the first carcass ply 51 is 3.0% or more and 30% or less of the tire cross-sectional height H.

The different color rubber portion 32 may be provided at a position that includes a tire maximum width position P1, or may be provided such that the different color display portion 33 is positioned at the tire maximum width position P1. Here, the tire maximum width position P1 refers to a position where a length in the tire axial direction WD of the pneumatic tire 1 is maximum when the tire is mounted on a standard rim, pressurized to a standard internal pressure, and subjected to a standard load.

As shown in FIG. 1, the different color rubber portion 32 is provided from the tire outer surface to the first turned-up portion 51B of the first carcass ply 51 in the tire axial direction WD in a region at the inner side in the tire radial direction RD of the side wall 30. By providing the different color rubber portion 32 in this manner, the different color rubber portion 32 radially divides the black side wall rubber 31 in the vicinity of the center portion in the tire radial direction RD, and the upper side wall rubber 31A positioned at the outer side in the tire radial direction RD of the different color rubber portion 32 and a lower side wall rubber 31B positioned at the inner side in the tire radial direction RD of the different color rubber portion 32 are formed.

In the present embodiment, the side wall rubber 31 is divided in the tire radial direction RD by the different color rubber portion 32. However, the side wall rubber 31 may be provided between the different color rubber portion 32 and the first turned-up portion 51B of the first carcass ply 51, and the upper side wall rubber 31A and the lower side wall rubber 31B may be connected.

The tire radially outer end 32E1 of the different color rubber portion 32 may be positioned at the tire radially outer side of the tire radially outer end (tip end) 22E of the bead filler 22, and a tire radially inner end 32E2 of the different color rubber portion 32 may be positioned at the tire radially inner side of the tip end 22E of the bead filler 22. That is, the tip end 22E of the bead filler 22 may overlap the different color rubber portion 32 in the tire axial direction WD via the first turned-up portion 51B and the second turned-up portion 52B of the carcass 50. In the present embodiment, the tip end 22E of the bead filler 22 extends toward the tire radially outer side to a position overlapping the different color display portion 33 in the tire axial direction WD.

By disposing the tip end 22E of the bead filler 22 to overlap the different color rubber portion 32 in the tire axial direction WD in this manner, the rigidity of the side wall 30 can be increased and the strain of the entire side wall can be prevented. In addition, since the different color rubber portion 32 does not overlap the bead filler 22 in the tire axial direction WD over the entire tire radial direction, ride comfort is less likely to deteriorate.

In the present embodiment, both ends of the different color rubber portion 32 in the tire radial direction are inclined to be narrower toward the tire axially inner side, and a length in the radial direction of the tire outer surface of the different color rubber portion 32 is set longer than a length in the radial direction of the tire inner surface thereof.

A cross-sectional shape of the different color rubber portion 32 may be formed in various shapes. For example, both ends of the different color rubber portion 32 in the tire radial direction may be inclined to be wider toward the tire axially inner side. Both ends of the different color rubber portion 32 in the tire radial direction may be arranged approximately parallel to the tire axial direction. One end in the tire radial direction of the different color rubber portion 32 may be inclined with respect to the tire axial direction, and the other end in the tire radial direction may be arranged approximately parallel to the tire axial direction.

In the present embodiment, an interface 5 between the lower side wall rubber 31B and the rim strip rubber 3 is inclined toward the inner side in the tire radial direction RD as the interface 5 extends toward the outer side in the tire axial direction WD, and is inclined approximately parallel to the same direction as the interface 4 between the different color rubber portion 32 and the lower side wall rubber 31B.

In the present embodiment, the tire radially inner end 32E2 of the different color rubber portion 32 is positioned at an inner side in the tire radial direction RD of a tire radially outer end 3E of the rim strip rubber 3, and overlaps a tire radially outer end of the rim strip rubber 3 in the tire axial direction via the lower side wall rubber 31B.

### (6) Side Reinforcing Layer 80

The side reinforcing layer 80 is a rubber layer formed by arranging a plurality of reinforcing cords made of steel cords or organic fiber cords in parallel at predetermined intervals and being coated with rubber. The side reinforcing layer 80 is provided between the bead filler 22 and the second turned-up portion 52B. A tire radially inner end 80E2 of the side reinforcing layer 80 is disposed at a position overlapping the bead core 21 in the tire axial direction WD, extends outward in the tire radial direction RD along the outer side in the tire axial direction WD of the bead filler 22, and at least extends to and terminates at the outer side in the tire radial direction RD of the lower side wall rubber 31B.

That is, the tire radially inner end 80E2 of the side reinforcing layer 80 is positioned at an inner side in the tire radial direction RD of a tire axially inner end 5E of the interface 5 between the rim strip rubber 3 and the lower side wall rubber 31B, and a tire radially outer end 80E1 is positioned at an outer side in the tire radial direction RD of a tire axially inner end 4E of the interface 4 between the lower side wall rubber 31B and the different color rubber portion 32.

The tire radially outer end 80E1 of the side reinforcing layer 80 may be provided at a position overlapping the different color rubber portion 32 in the tire axial direction WD, or provided at a position overlapping the different color display portion 33 of the different color rubber portion 32 in the tire axial direction WD, or provided at a position overlapping the upper side wall rubber 31A in the tire axial direction WD. The tire radially outer end 80E1 of the side reinforcing layer 80 may be provided at the inner side in the tire radial direction RD of the tire maximum width position P1, or may be provided at the outer side in the tire radial direction RD of the tire maximum width position P1.

### (7) Effects

In the pneumatic tire 1 of the present embodiment, the length C in the tire radial direction from the tire radially outer end 32E 1 of the different color rubber portion 32 to the annular protrusion 47 is 8% or more and 28% or less of the tire cross-sectional height H, and a distance from the vicinity of the boundary between the side wall 30 and the tread 40 is ensured, and thus, a stress acting on the interface between the different color rubber portion 32 and the upper side wall rubber 31A can be reduced, the separation at the interface is prevented from occurring, and durability can be improved.

In the low-profile pneumatic tire having the tire cross-sectional height H of 85 mm or more and 150 mm or less as in the present embodiment, the strain is likely to concentrate in the vicinity of the boundary between the tread 40 and the side wall 30, and thus by setting the length C and ensuring the distance from the boundary between the tread 40 and the side wall 30 as described above, the stress acting on the interface between the different color rubber portion 32 and the upper side wall rubber 31A can be reduced.

In the pneumatic tire 1 of the present embodiment, the first turned-up portion 51B of the first carcass ply 51 extends toward the tire axially inner side of the outer end 70E of the belt 70, and the first turned-up end 51BE overlaps the belt 70 in the normal direction of the turned-up portion 51B, and thus, by increasing the rigidity in the vicinity of the boundary between the tread 40 and the side wall 30, the strain is prevented, the separation at the interface 6 between the different color rubber portion 32 and the upper side wall rubber 31A can be prevented from occurring, and the durability can be improved.

As in the present embodiment, the first turned-up end 51BE is disposed at the inner side in the tire axial direction WD of the tire axially outer end 72E of the second belt ply 72, and the first turned-up end 51BE overlaps the second belt ply 72 in the normal direction of the first turned-up portion 51B, so that a reinforcing effect in the vicinity of the boundary between the tread 40 and the side wall 30 is enhanced, and the separation at the interface 6 can be further prevented from occurring.

The second turned-up portion 52B of the second carcass ply 52 extends to the outer side in the tire radial direction RD of the interface 6 between the different color rubber portion 32 and the upper side wall rubber 31A, and the second turned-up end 52BE overlaps the tread rubber 41 via the upper side wall rubber 31A. Therefore, the rigidity in the vicinity of the interface 6 between the different color rubber portion 32 and the upper side wall rubber 31A can be increased, the separation at the interface 6 can be prevented from occurring, and the durability can be improved.

The second turned-up end 52BE does not overlap the belt 70 in the normal direction of the second turned-up portion 52B, and the distance from the belt 70 is ensured. Therefore, the ends of the belt plies 71 and 72 and the carcass plies 51 and 52 in which the strain is likely to concentrate are not disposed to overlap in the vicinity of the boundary between the tread rubber 41 and the side wall rubber 31, the tire durability can be improved, and air is difficult to remain between components during tire manufacturing.

In the present embodiment, the length D in the tire radial direction from the tire axially inner end 6a of the interface 6 to the first turned-up end 51BE of the first turned-up portion 51B is set to 3.0% or more and 30% or less of the tire cross-sectional height H. When the length D is 3.0% or more of the tire cross-sectional height H, the distance between the interface 6 and the first turned-up portion 51B is ensured while increasing the rigidity in the vicinity of the different color rubber portion 32, and the tire durability can be improved. When the length D is 30% or less of the tire cross-sectional height H, weight is not excessively increased, and rolling resistance and fuel economy do not decrease.

By providing the side reinforcing layer 80 between the bead filler 22 and the second turned-up portion 52B as in the present embodiment, the rigidity of the entire side wall 30 is increased, the input load is reduced, and the strain at the interfaces 4 and 6 between the different color rubber portion 32 and the side wall rubber 31 is prevented.

In the pneumatic tire 1 of the present embodiment, in a tire axially cross section in a standard rim assembling and internal pressure uninflated state, a tire thickness from the tire inner surface to the tire outer surface is smaller at a tire axial center than at a ground contact end, and thus the tread 40 is more likely to flex and deform. Accordingly, flexure of the entire tire is more easily dispersed to the tread 40, so that a flexural deformation that occurs in the side wall 30 can be prevented, the separation at the interface between the different color rubber portion 32 and the side wall rubber 31 can be prevented, and the durability can be improved.

In particular, in the case of the low-profile pneumatic tire having a tire cross-sectional height H of 150 mm or less, if the different color display portion 33 is disposed at a conspicuous position on the side wall 30, the different color rubber portion 32 is disposed in the vicinity of the tire maximum width position P1 which is likely to deform when a load is applied, but in the present embodiment, a configuration in which the tread 40 is likely to flex and deform is adopted, and thus the deformation in the vicinity of the tire maximum width position P1 is reduced, the separation at the interface between the different color rubber portion 32 and the side wall rubber 31 can be prevented, and the durability can be improved.

In the present embodiment, by setting an angle of the belt cord provided on the belt 70 with respect to the tire circumferential direction CD to 22 degrees or more and 28 degrees or less, the tread 40 can be constrained in the tire radial direction while allowing a moderate deformation, and the flexural deformation of the side wall 30 can be prevented without impairing tire running performance, the separation at the interface between the different color rubber portion 32 and the side wall rubber 31 can be prevented, and the durability can be improved.

By adjusting the belt angle of the belt cord with respect to the tire circumferential direction CD within the above range, a ground contact pressure of the tire is uniform, and the strain is dispersed to the entire tire, thereby preventing the flexural deformation in the side wall 30 and the bead portion 20.

In the present embodiment, by disposing the tip end 22E of the bead filler 22 to overlap the different color rubber portion 32 when viewed from the tire axial direction, the interface between the different color rubber portion 32 and the side wall rubber 31 can be reinforced, the separation at the interface between the different color rubber portion 32 and the side wall rubber 31 can be prevented from occurring, and the durability can be improved.

In the case of the low-profile pneumatic tire having a tire cross-sectional height H of 150 mm or less, if the different color display portion 33 is disposed at a conspicuous position on the side wall 30, the different color display portion 33 is easily affected by the strain that occurs in the vicinity of the boundary between the side wall 30 and the tread 40. In the pneumatic tire 1 of the present embodiment, by setting the length C in the tire radial direction from the tire radially outer end 32E1 of the different color rubber portion 32 to the annular protrusion 47 to be 8% or more and 28% or less of the tire cross-sectional height H, a distance from the vicinity of the boundary between the side wall 30 and the tread 40 is ensured, and by disposing the first turned-up portion 51B of the first carcass ply 51 and the second turned-up portion 52B of the second carcass ply 52 at a tire radially outer side of the different color rubber portion 32 to increase the rigidity of the vicinity of the interface 6 between the upper side wall rubber 31A and the different color rubber portion 32, the separation at the interface 6 can be prevented from occurring.

In the present embodiment, the first turned-up end 51BE is disposed at the tire radially outer side of the second turned-up end 52BE, and two ends are disposed apart, thereby preventing air from entering between the first turned-up portion 51B and the second turned-up portion 52B, and the durability can be improved.

### (8) Modification

Next, a modification will be described. Various modifications can be made to the above embodiments without departing from the gist of the invention. Although a plurality of modifications will be described below, any one of the plurality of modifications described below may be applied to the above embodiment, or any two or more of the modifications described below may be applied in combination. In addition to the modifications below, various omissions, substitutions, and changes can be made without departing from the gist of the invention. In the drawings showing the modifications, the same components as those in the above embodiment are denoted by the same reference numerals as those in the above embodiment.

### (8-1) Modification 1

In the present modification, a void ratio of each of regions is set such that a central void ratio, which is a void ratio of a central region TC of the tread 40, is greater than a shoulder void ratio, which is a void ratio of a shoulder region TS.

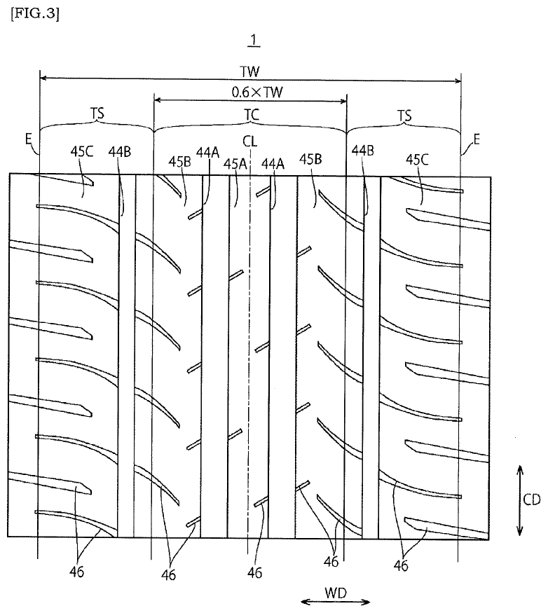

Specifically, as shown in FIG. 3, if a length in the tire axial direction WD of the region sandwiched between the ground contact ends E of the tread 40, that is, a distance between the ground contact ends E on both sides in the tire axial direction WD, is defined as a ground contact width TW, the central region TC refers to a region in a range of 60% of the ground contact width TW centered on the tire axial center CL. The shoulder region TS is a region extending from the central region TC to each of the ground contact ends E on both sides in the tire axial direction WD.

The central void ratio refers to a ratio of an opening area of recess portions provided in the central region TC to an area of the central region TC, that is, the central void ratio is an area ratio of a non-ground contact portion to the central region TC. The shoulder void ratio refers to a ratio of an opening area of the recess portions provided in the shoulder region TS to an area of the shoulder region TS, that is, the shoulder void ratio is an area ratio of the non-ground contact portion to the shoulder region TS.

Here, an area of the non-ground contact portion is a sum of opening areas of the main grooves 44A and 44B and the lateral grooves 46. Note that if narrow grooves with a groove width of 1.5 mm or less, called sipes, are provided in the central region TC or the shoulder region TS, opening areas of these narrow grooves are also included in the area of the non-ground contact portion.

In the present modification, the central void ratio is greater than the shoulder void ratio, and thus the tread 40 is more likely to flex and deform. Accordingly, the strain that is likely to concentrate in the side wall 30 when a load is applied is dispersed to the central region of the tread, and the flexural deformation that occurs in the side wall 30 can be prevented, and the separation at the interface between the different color rubber portion 32 and the side wall rubber 31 can be prevented.

### (8-2) Modification 2

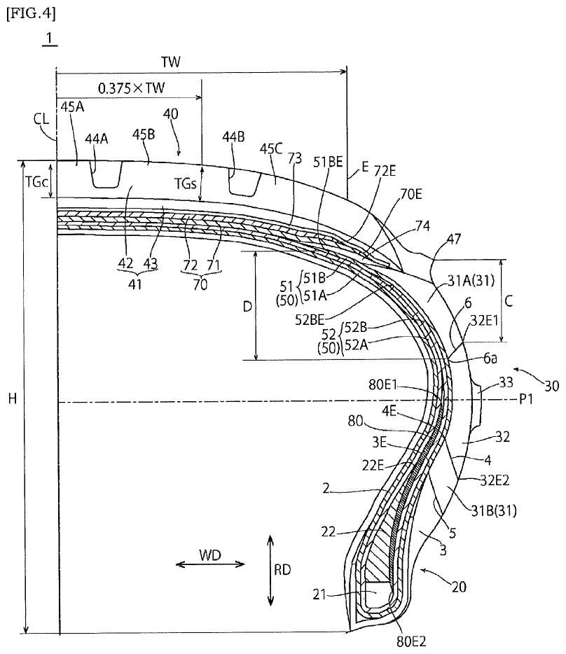

As shown in FIG. 4, in Modification 2, a rubber thickness TGc of the cap rubber layer 42 of the tread 40 at the tire axial center CL is set smaller than a rubber thickness TGs of the cap rubber layer 42 at a position 37.5% of the ground contact width TW away from the tire axial center CL toward the outer side in the tire axial direction WD. In the present modification, the base rubber layer 43 uses a rubber composition having lower rubber hardness than that of the rubber composition constituting the cap rubber layer 42.

In the present modification, a thickness of the cap rubber layer 42 is set smaller at the tire axial center CL than that at a position away from the tire axial center CL toward the outer side in the tire axial direction WD, and thus the tread 40 is more likely to flex and deform. Accordingly, the strain that is likely to concentrate in the side wall 30 when a load is applied is dispersed to the tread 40, and the flexural deformation that occurs in the side wall 30 can be prevented, and the separation at the interface between the different color rubber portion 32 and the side wall rubber 31 can be prevented.

### (8-3) Modification 3

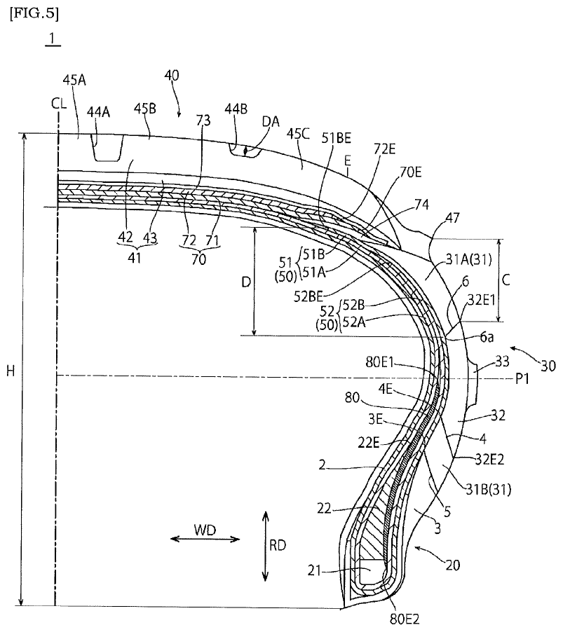

As shown in FIG. 5, in Modification 3, a groove depth DA of the center main groove 44A is greater than a groove depth DB of the shoulder main groove 44B. The groove depths of the center main groove 44A and the shoulder main groove 44B are set in this way, so that the tread 40 is more likely to flex and deform, and the strain that is likely to concentrate in the side wall 30 when a load is applied is dispersed to the central region of the tread 40, so that the flexural deformation that occurs in the side wall 30 can be prevented, and the separation at the interface between the different color rubber portion 32 and the side wall rubber 31 can be prevented.

FIG. 5 illustrates a case where two center main grooves 44A and two shoulder main grooves 44B are provided. In other cases where the tread 40 has three or more main grooves, such as a case where one center main groove is provided at the tire axial center CL of the tread 40 and shoulder main grooves are provided on both sides of the center main groove in the tire axial direction, thereby providing three main grooves in the tread 40, or a case where middle main grooves and shoulder main grooves are provided on both sides of one center main groove in the tire axial direction, thereby providing five main grooves in the tread 40, by setting the groove depth of the center main groove greater than the groove depth of the shoulder main groove, the strain that is likely to concentrate in the side wall 30 when a load is applied is dispersed to a central region of the tread, the flexural deformation in the side wall 30 is prevented, and the separation at the interface between the different color rubber portion 32 and the side wall rubber 31 can be prevented from occurring.

### (8-4) Modification 4

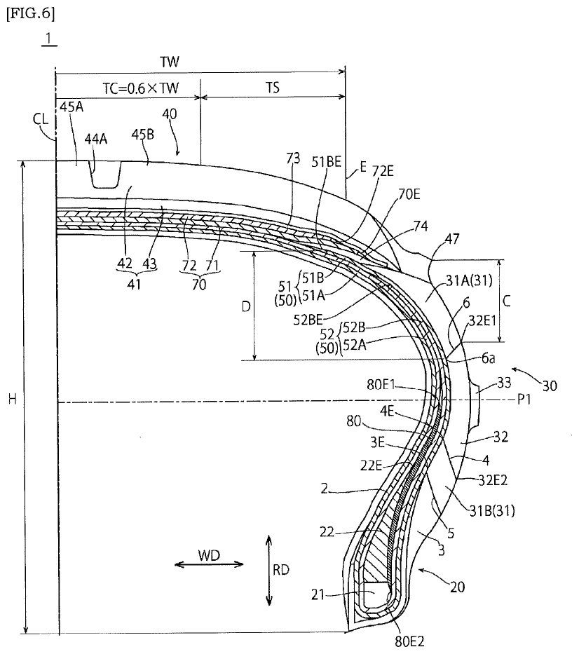

As shown in FIG. 6, in Modification 4, when in a region sandwiched by the ground contact ends E of the tread 40, a range of 60% of a ground contact width TW centered on the tire axial center CL is defined as a central region TC, and each of regions from both sides in the tire axial direction WD of the central region TC to the ground contact ends E is defined as a shoulder region TS, the center main groove 44A extending in the tire circumferential direction CD is provided in the central region TC, and the main groove extending in the tire circumferential direction CD is not provided in the shoulder region TS.

In the present modification, the tread 40 is also more likely to flex and deform, the strain that is likely to concentrate in the side wall 30 when a load is applied is dispersed to the tread 40, and the flexural deformation that occurs in the side wall 30 can be prevented, and the separation at the interface between the different color rubber portion 32 and the side wall rubber 31 can be prevented.

### (8-5) Modification 5

In the above embodiment, the first turned-up end 51BE of the first carcass ply 51 overlaps the belt 70 in the normal direction of the first turned-up portion 51B, and the second turned-up end 52BE of the second carcass ply 52 overlaps the tread rubber 41 without overlapping the belt 70 in the normal direction of the second turned-up portion 52B, but the disposing of the first turned-up end 51BE and the second turned-up end 52BE is not limited thereto.

For example, the first turned-up end 51BE may overlap the belt 70 in the normal direction of the first turned-up portion 51B, and the second turned-up end 52BE may overlap the upper side wall rubber 31A without overlapping the tread rubber 41 in the normal direction of the second turned-up portion 52B, or the first turned-up end 51BE may overlap the tread rubber 41 without overlapping the belt 70 in the normal direction of the first turned-up portion 51B, and the second turned-up end 52BE may overlap the upper side wall rubber 31A without overlapping the tread rubber 41 in the normal direction of the second turned-up portion 52B.

In the above embodiment, a case in which the carcass 50 is implemented by two carcass plies has been described, but the carcass 50 may be implemented by one carcass ply or three or more carcass plies. When the carcass 50 is implemented by one carcass ply or three or more carcass plies, at least one turned-up end of the carcass ply may overlap the belt 70 in a normal direction of the turned-up portion, or may overlap the tread rubber 41 without overlapping the belt 70.

### (8-6) Modification 6

The invention is not limited to the low-profile pneumatic tire having the tire cross-sectional height H of 150 mm or less as described in the above embodiment, and is also applicable to a pneumatic tire having a tire cross-sectional height H of more than 150 mm.

### (9) Examples

Hereinafter, Examples will be shown, but the invention is not limited to these Examples.

In order to show the effects of the above embodiment, pneumatic tires of Examples 1 to 3 and Comparative Examples were produced as prototypes.

The pneumatic tires of Examples 1 to 3 and Comparative Examples were radial tires having a cross-sectional shape shown in FIG. 1, having the tread pattern shown in FIG. 2, and having a tire size of 165/60R15, and the lengths C in the tire radial direction from the tire radially outer end 32E1 of the different color rubber portion 32 to the annular protrusion 47 were different. The length C, the tire cross-sectional height H, and the ratio of the length C to the tire cross-sectional height H of each of the pneumatic tires of Examples 1 to 3 and Comparative Examples are as shown in Table 1.

All examples had a cross-sectional height of 99 mm, and had the same configuration except for the length C.

Durability performance was evaluated for each of these tires. Evaluation methods are as follows.
Durability performance: a durability performance test was conducted in accordance with a method specified in JIS D4230. If the separation or other failure was not confirmed after completing a test stage 3, the tire was continued to be loaded, and a mileage until the failure was confirmed was measured, and was expressed as an index with a value for Example 1 set to 100. A higher index indicated better durability performance.
Appearance quality: each of the obtained pneumatic tires was visually inspected to confirm whether black rubber penetrated the different color display portion, and it was determined as “A” if the black rubber did not penetrate the different color display portion, and it was determined as “B” if the black rubber penetrated the different color display portion.

TABLE 1

| | Comparative | Example | Example | Example | Comparative |
|---|---|---|---|---|---|
| | Example 1 | 1 | 2 | 3 | Example 2 |
| Length C (mm) | 6 | 10 | 20 | 26 | 30 |
| Tire cross- | 99 | 99 | 99 | 99 | 99 |
| sectional | | | | | |
| height H (mm) | | | | | |
| Ratio (C/H) (%) | 6.1 | 10.1 | 20.2 | 26.3 | 30.3 |
| Durability | 88.9 | 100 | 120 | 150 | 150 |
| performance | | | | | |
| Appearance | A | A | A | A | B |
| quality | | | | | |

The results are shown in Table 1, and in Examples 1 to 3, the separation was unlikely to occur at the interface between the different color rubber portion 32 and the upper side wall rubber 31A, and excellent durability performance was exhibited. In Examples 1 to 3, the black rubber did not penetrate the different color display portion, and the appearance quality was also excellent.

On the other hand, in Comparative Example 1, the durability was inferior to that of Examples 1 to 3. In Comparative Example 2, the black rubber penetrated the different color display portion.

### REFERENCE SIGNS LIST

1: pneumatic tire
2: inner liner
3: rim strip rubber
20: bead portion
21: bead core
22: bead filler
30: side wall
31: side wall rubber
32: different color rubber portion
33: different color display portion
40: tread
41: tread rubber
42: cap rubber layer
43: base rubber layer
44A: center main groove
44B: shoulder main groove
45A: center land portion
45B: middle land portion
45C: shoulder land portion
46: lateral groove
47: annular protrusion
50: carcass
51: first carcass ply
51A: first main portion
51B: first turned-up portion
52: second carcass ply
52A: second main portion
52B: second turned-up portion
70: belt
71: first belt ply
72: second belt ply

What is claimed is:

1. A pneumatic tire comprising:
a pair of bead portions including a pair of bead cores spaced apart in a tire axial direction and bead fillers each provided on a tire radially outer side of one of the bead cores;
a pair of side walls provided on the tire radially outer side from the pair of bead portions;
a tread provided between the pair of side walls and having a belt including a plurality of cords covered with rubber and a tread rubber provided on the tire radially outer side of the belt;
a carcass ply having a main portion provided between the pair of bead portions, and a turned-up portion extending from the main portion and turned up around the bead cores from a tire axially inner side toward a tire axially outer side; and
a different color rubber portion provided on the tire axially outer side of the carcass ply in the side walls and made of rubber having a lower carbon black content than rubber constituting the side walls, wherein
the pneumatic tire is formed by a tire vulcanization mold having a sector that forms at least a part of the tread and a side plate that comes into contact with the sector and forms at least a part of the side walls,
a length in a tire radial direction from a tire radially outer end of the different color rubber portion to an annular protrusion, which is formed at a boundary between the sector and the side plate and continuous in a tire circumferential direction, is 8% or more to 28% or less of a tire cross-sectional height, and
a tire radially outer end of the turned-up portion overlaps the belt in a normal direction of the turned-up portion.

2. The pneumatic tire according to claim 1, wherein
the carcass ply includes
a first carcass ply including a first main portion extending from the tread through the side walls to the bead cores, and a first turned-up portion extending from the first main portion and turned up around the bead cores from the tire axially inner side to the tire axially outer side; and
a second carcass ply including a second main portion disposed on a tire radially outer side of the first main portion in the tread and extending from the tread through the side walls to the bead cores, and a second turned-up portion extending from the second main portion and turned up around the bead cores from the tire axially inner side to the tire axially outer side,
a tire radially outer end of the first turned-up portion overlaps the belt in a normal direction of the first turned-up portion, and
a tire radially outer end of the second turned-up portion overlaps the tread rubber without overlapping the belt in a normal direction of the second turned-up portion.

3. The pneumatic tire according to claim 1, wherein
a length D in the tire radial direction from a tire axially inner end of an interface between the different color rubber portion and the side wall provided on a tire radially outer side of the different color rubber portion to the tire radially outer end of the turned-up portion is 3% or more and 30% or less of a tire cross-sectional height H.

4. The pneumatic tire according to claim 1, wherein
the belt includes a first belt disposed at an innermost position in the tire radial direction, and a second belt disposed on a tire radially outer side of the first belt and shorter than the first belt in the tire axial direction, and
the tire radially outer end of the turned-up portion overlaps the second belt in the normal direction of the turned-up portion.

5. The pneumatic tire according to claim 1, further comprising:
a rim strip rubber provided on a tire axially outer side of each of the bead portions and including a portion in contact with a wheel rim; and
a side reinforcing layer including a reinforcing cord provided between the bead fillers and the turned-up portion, wherein
each of the side walls includes an upper side wall rubber provided on a tire radially outer side of the different color rubber portion, and a lower side wall rubber provided between the different color rubber portion and the rim strip rubber, and
at least a part of the side reinforcing layer overlaps in the tire axial direction with a region from an interface between the rim strip rubber and the lower side wall rubber to an interface between the lower side wall rubber and the different color rubber portion.

6. The pneumatic tire according to claim 1, wherein
in a tire axially cross section in a standard rim assembling and internal pressure uninflated state, a tire thickness from a tire inner surface to a tire outer surface is smaller at a tire axial center than at a ground contact end.

7. The pneumatic tire according to claim 1, wherein
in a region sandwiched by ground contact ends of the tread, a range of 60% of a ground contact width centered on a tire axial center is defined as a central region, and a tire axially outer side of the central region is defined as a shoulder region, a ratio of an opening area of a recess portion provided in the central region to an area of the central region is defined as a central void ratio, and a ratio of an opening area of a recess portion provided in the shoulder region to an area of the shoulder region is defined as a shoulder void ratio, and in this case, the central void ratio is larger than the shoulder void ratio.

8. The pneumatic tire according to claim 6, wherein
an inclination angle of each of the cords with respect to the tire circumferential direction is 22 degrees or more and 28 degrees or less.

9. The pneumatic tire according to claim 6, wherein
rubber hardness of the tread rubber is 52 or more and 68 or less.

10. The pneumatic tire according to claim 6, wherein
tire radially outer ends of the bead fillers overlap the different color rubber portion in the tire axial direction.

11. The pneumatic tire according to claim 6, wherein
the tread rubber includes a cap rubber layer on which a tread surface is formed, and a base rubber layer provided on a tire radially inner side of the cap rubber layer and having lower rubber hardness than the cap rubber layer, and
a rubber thickness of the cap rubber layer at the tire axial center is smaller than a rubber thickness of the cap rubber layer at a position 37.5% of a ground contact width away from the tire axial center toward a tire axially outer side.

12. The pneumatic tire according to claim 6, wherein
the tread has at least three main grooves extending in the tire circumferential direction, including at least one center main groove and a pair of shoulder main grooves positioned on both sides of the center main groove in the tire axial direction, and
a groove depth of the center main groove is greater than groove depths of the shoulder main grooves.

13. The pneumatic tire according to claim 6, wherein
when in a region sandwiched by the ground contact ends of the tread, a range of 60% of a ground contact width centered on the tire axial center is defined as a central region, and a tire axially outer side of the central region is defined as a shoulder region,
a main groove extending in the tire circumferential direction is provided in the central region, and the main groove extending in the tire circumferential direction is not provided in the shoulder region.

14. The pneumatic tire according to claim 1, wherein
the carcass ply includes
a first carcass ply including a first main portion extending from the tread through the side walls to the bead cores, and a first turned-up portion extending from the first main portion and turned up around the bead cores from the tire axially inner side to the tire axially outer side; and
a second carcass ply including a second main portion disposed on a tire radially outer side of the first main portion in the tread and extending from the tread through the side walls to the bead cores, and a second turned-up portion extending from the second main portion and turned up around the bead cores from the tire axially inner side to the tire axially outer side, and
in the pneumatic tire having a tire cross-sectional height of 150 mm or less,
tire radially outer ends of the first turned-up portion and the second turned-up portion are disposed on a tire radially outer side of the different color rubber portion.

15. The pneumatic tire according to claim 14, wherein
the tire radially outer end of the first turned-up portion is disposed on a tire radially outer side of the tire radially outer end of the second turned-up portion.

16. The pneumatic tire according to claim 14, further comprising:
a rim strip rubber provided on a tire axially outer side of each of the bead portions and including a portion in contact with a wheel rim; and
a side reinforcing layer including a reinforcing cord provided between the bead filler and the second turned-up portion, wherein
each of the side walls includes an upper side wall rubber provided on a tire radially outer side of the different color rubber portion, and a lower side wall rubber provided between the different color rubber portion and the rim strip rubber, and
the side reinforcing layer is provided from a position at a tire radially inner side of a tire axially inner end of an interface between the rim strip rubber and the lower side wall rubber to a position at a tire radially outer side of a tire axially inner end of an interface between the lower side wall rubber and the different color rubber portion.

17. The pneumatic tire according to claim 14, wherein
tire radially outer ends of the bead fillers overlap the different color rubber portion in the tire axial direction.
